(19) United States
(12) Patent Application Publication
(10) Pub. No.: US 2013/0057531 A1
(43) Pub. Date: Mar. 7, 2013

(54) DISPLAY DRIVING CIRCUIT AND DISPLAY DEVICE INCLUDING THE SAME

(71) Applicants: Hun LIM, Yongin-si (KR); Seung-Jung LEE, Hwaseong-si (KR)

(72) Inventors: Hun LIM, Yongin-si (KR); Seung-Jung LEE, Hwaseong-si (KR)

(73) Assignee: SAMSUNG ELECTRONICS CO., LTD., Suwon-si (KR)

(21) Appl. No.: 13/597,682

(22) Filed: Aug. 29, 2012

(30) Foreign Application Priority Data
Sep. 5, 2011 (KR) 10-2011-0089691

(51) Int. Cl. G09G 5/00

(52) U.S. Cl. 345/211

(57) ABSTRACT

A display driving circuit includes a semiconductor die, a logic control unit, a gray-scale voltage generation unit and a driving unit. The logic control unit is on a central region of the semiconductor die, and is configured to control the display driving circuit based on a control signal. The gray-scale voltage generation unit is on an edge region of the semiconductor die, and is configured to generate a plurality of gray-scale voltages based on an input voltage. The driving unit is on a region of the semiconductor die between the logic control unit and the gray-scale voltage generation unit, and is configured to generate a plurality of driving voltages based on the plurality of gray-scale voltages and input data.

### CROSS-REFERENCE TO RELATED APPLICATION

This application claims priority under 35 USC §119 to Korean Patent Application No. 2011-0089691, filed on Sep. 5, 2011 in the Korean Intellectual Property Office (KIPO), the contents of which are herein incorporated by reference in their entirety.

### BACKGROUND

1. Technical Field

Example embodiments relate to a display apparatus and/or to a display driving circuit and a display device including the display driving circuit.

2. Description of the Related Art

In general, a display device includes a display panel for displaying an image and a display driving circuit for driving the display panel. The display driving circuit includes a data driver for applying a voltage signal to data lines of the display panel and a gate driver for selectively activating gate lines of the display panel. The data driver may be implemented as an integrated circuit (IC) chip. As semiconductor process technology continues to develop, various methods have been proposed to decrease the size of the data driver IC chip.

### SUMMARY

Accordingly, the inventive concepts are provided to substantially obviate one or more problems due to limitations and disadvantages of the related art.

At least one example embodiment provides a display driving circuit with relatively small size by modifying a layout of the display driving circuit.

At least one example embodiment provides a display device including the display driving circuit.

According to at least one example embodiment, a display driving circuit includes a semiconductor die, a logic control unit, a gray-scale voltage generation unit and a driving unit. The logic control unit is on a central region of the semiconductor die, and is configured to control the display driving circuit based on a control signal. The gray-scale voltage generation unit is on an edge region of the semiconductor die, and is configured to generate a plurality of gray-scale voltages based on an input voltage. The driving unit is on a region of the semiconductor die between the logic control unit and the gray-scale voltage generation unit, and is configured to generate a plurality of driving voltages based on the plurality of gray-scale voltages and input data.

The semiconductor die may have a first side that is substantially parallel to a first direction and a second side that is substantially parallel to a second direction, the second direction is different from the first direction. The gray-scale voltage generation unit may be adjacent to the first side and arranged in the first direction.

A length of the first side may be smaller than a length of the second side.

The display driving circuit may further include a voltage input pad unit. The voltage input pad unit may receive the input voltage, and may include a plurality of voltage input pads on an active surface of the semiconductor die. The input voltage may be supplied to the gray-scale voltage generation unit through a metal wire layer above the active surface of the semiconductor die.

The metal wire layer may include a plurality of metal wire patterns and an insulation layer. The plurality of metal wire patterns may be above the active surface of the semiconductor die. Each metal wire pattern may electrically connect the gray-scale voltage generation unit to one of the plurality of voltage input pads. The insulation layer may be on the plurality of metal wire patterns.

The display driving circuit may further include a signal input pad unit. a signal input pad unit may receive the control signal and the input data. The input data may include first input data and second input data that are a pair of differential data. The logic control unit may include a comparison block configured to compare the first input data with the second input data to generate internal data.

The gray-scale voltage generation unit may include a first gray-scale voltage generation unit and a second gray-scale voltage generation unit. The plurality of gray-scale voltages may include first gray-scale voltages and second gray-scale voltages. The first gray-scale voltage generation unit may be adjacent to a first side of the semiconductor die and arranged in a first direction along the first side of the semiconductor die, the first gray-scale voltage generation unit configured to generate the first gray-scale voltages. The second gray-scale voltage generation unit may be adjacent to a second side of the semiconductor die, may be arranged in the first direction along the second side of the semiconductor die and may be configured to generate the second gray-scale voltages. The first side may be substantially parallel to the first direction, and the second side may correspond to the first side. The driving unit may include a first driving unit and a second driving unit. The first driving unit may be formed in a first region of the semiconductor die between the logic control unit and the first gray-scale voltage generation unit. The second driving unit may be formed in a second region of the semiconductor die between the logic control unit and the second gray-scale voltage generation unit.

The driving unit may include a plurality of driver cells disposed along a second direction, the second direction being different from the first direction.

The plurality of driver cells may include first driver cells disposed in a first row of the driving unit along the second direction and second driver cells disposed in a second row of the driving unit along the second direction. Each first driver cell may include a first decoder configured to select one of the first gray-scale voltages. Each second driver cell may include a second decoder configured to select one of the second gray-scale voltages. The second row may be adjacent to the first row in the first direction.

The display driving circuit may further include a first metal wire and a second metal wire. The first metal wire may supply the first gray-scale voltages to the first decoder. The second metal wire may supply the second gray-scale voltages to the second decoder.

The plurality of driver cells may include first driver cells and second driver cells. Each first driver cell may include a first decoder configured to select one of the first gray-scale voltages. Each second driver cell may include a second decoder configured to select one of the second gray-scale voltages. The first driver cells and the second driver cells may be alternately disposed along the second direction.

Each driver cell may include a data transmission unit, a decoder and an output buffer. The data transmission unit may generate first data by processing the input data. The decoder may select one of the plurality of gray-scale voltages based on the first data. The output buffer may generate one of the plurality of driving voltages by buffering the selected gray-scale voltage.

The data transmission unit may include a shift register and a data latch. The shift register may generate a latch clock signal based on the control signal. The data latch may generate the first data by latching the input data based on the latch clock signal.

The display driving circuit may further include a voltage output pad unit. The voltage output pad unit may output the plurality of driving voltages.

According to at least one example embodiment, a display device includes a display panel, a gate driver, a data driver and a controller. The display panel includes a plurality of gate lines and a plurality of data lines. The gate driver selectively enables the gate lines of the display panel. The data driver applies a plurality of driving voltages to the data lines of the display panel. The controller is configured to control the gate driver and the data driver. The data driver includes a semiconductor die, a logic control unit, a gray-scale voltage generation unit and a driving unit. The logic control unit is on a central region of the semiconductor die, and is configured to control the data driver based on a control signal provided from the controller. The gray-scale voltage generation unit is formed in an edge region of the semiconductor die, and is configured to generate a plurality of gray-scale voltages based on an input voltage. The driving unit is on a region of the semiconductor die between the logic control unit and the gray-scale voltage generation unit, and is configured to generate the plurality of driving voltages based on the plurality of gray-scale voltages and input data provided from the controller.

According to at least one example embodiment, a display driving circuit may include: a first voltage generation unit on an end of a substrate; a second voltage generation unit on an opposite end of the substrate; and a plurality of circuit units between the first voltage generation unit and the second voltage generation unit, the first voltage generation unit, the second voltage generation unit, and the plurality of circuit units being configured to drive a display device.

The plurality of circuit units may include: a logic control unit on a central region of the substrate; a first driving unit between the logic control unit and the first voltage generation unit; and a second driving unit between the logic control unit and the second voltage generation unit.

The first and second driving units may include: a first driver cell disposed in a first row of the first and second driving units, each first driver cell including at least one first decoder; and a second driver cell disposed in a second row of the first and second driving units, each second driver cell including at least one second decoder.

The first and second driving units may include: a first driver cell including at least one first decoder; and a second driver cell including at least one second decoder. The at least one first decoder and the at least one second decoder may be disposed in a first row of the first and second driving units. The at least one first decoder and the at least one second decoder may be alternately arranged in the first row.

The first and second driving units may include: a first driver cell disposed in a first row of the first and second driving units; and a second driver cell disposed in a second row of the first and second driving units. The first driver cell and the second driver cell may include at least one first decoder adjacent to at least one second decoder.

Accordingly, in a display driving circuit according to at least one example embodiment, the gray-scale voltage generation unit is not formed in the central region of the semiconductor die, but is formed in the edge region of the semiconductor die. The gray-scale voltage generation unit is formed adjacent to a short side of the semiconductor die. The logic control unit may include at least one of other circuit elements that are not included in a logic control unit of a conventional display driving circuit, and/or may have a relatively small size without including the gray-scale voltage generation unit. Thus, the display driving circuit may have a relatively small size.

### BRIEF DESCRIPTION OF THE DRAWINGS

Illustrative, non-limiting example embodiments will be more clearly understood from the following detailed description and the accompanying drawings, in which:

FIG. 1 is a diagram illustrating a layout of a display driving circuit according an example embodiment.

FIG. 2 is a block diagram describing an operation of the display driving circuit of FIG. 1.

FIG. 3 is a diagram illustrating an example of a layout for the display driving circuit of FIG. 1.

FIG. 4 is a block diagram describing an operation of the display driving circuit of FIG. 3.

FIG. 5 is a diagram illustrating another example of a layout for the display driving circuit of FIG. 1.

FIGS. 6A and 6B are diagrams describing the layout for the display driving circuit of FIG. 5.

FIG. 7 is a diagram illustrating still another example of a layout for the display driving circuit of FIG. 1.

FIG. 8 is a diagram illustrating still another example of a layout for the display driving circuit of FIG. 1.

FIG. 9 is a block diagram describing an operation of the display driving circuit of FIG. 8.

FIG. 10 is a diagram illustrating still another example of a layout for the display driving circuit of FIG. 1.

FIG. 11 is a diagram illustrating still another example of a layout for the display driving circuit of FIG. 1.

FIG. 12 is a block diagram describing an operation of the display driving circuit of FIG. 11.

FIG. 13 is a diagram illustrating still another example of a layout for the display driving circuit of FIG. 1.

FIG. 14 is a block diagram illustrating a display device according to an example embodiment.

FIGS. 15, 16 and 17 are block diagrams illustrating integrated circuit packages according to an example embodiment.

FIG. 18 is a block diagram illustrating an electronic system including the display device according to an example embodiment.

### DETAILED DESCRIPTION OF EXAMPLE EMBODIMENTS

Various example embodiments will be described more fully with reference to the accompanying drawings, in which embodiments are shown. Inventive concepts may, however, be embodied in many different forms and should not be construed as limited to the embodiments set forth herein. Rather, these example embodiments are provided so that this disclosure will be thorough and complete, and will fully convey the scope of the inventive concepts to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the inventive concepts. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other.

Spatially relative terms, such as “below”, “beneath”, “lower”, “above”, “upper”, and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

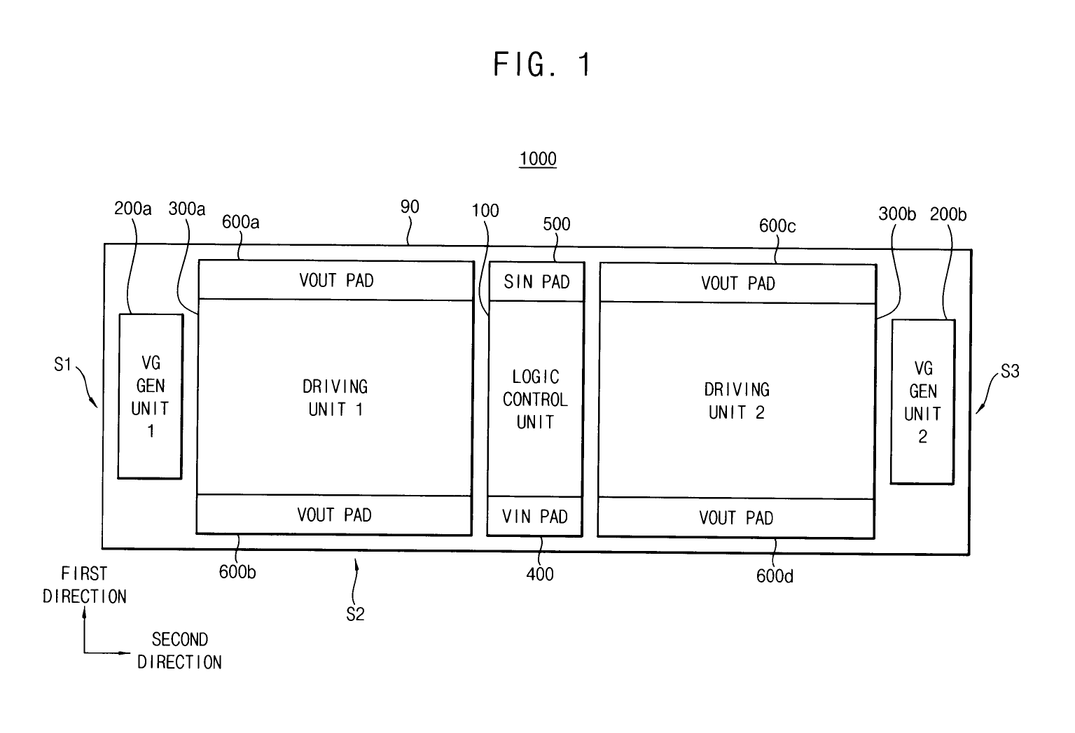

FIG. 1 is a diagram illustrating a layout for a display driving circuit according to example embodiments.

Referring to FIG. 1, a display driving circuit 1000 includes a semiconductor die 90, a logic control unit 100, gray-scale voltage generation units 200a and 200b, and driving units 300a and 300b. The display driving circuit 1000 may further include a voltage input pad unit 400, a signal input pad unit 500, and voltage output pad units 600a, 600b, 600c and 600d.

The display driving circuit 1000 may be implemented as a semiconductor chip, such as an integrated circuit (IC) chip. In a manufacturing process of the semiconductor chip, a front-end process may be performed such that a plurality of semiconductor devices having the same structure are integrated in one wafer, and then a back-end process may be performed such that the integrated semiconductor devices are cut off into distinct semiconductor dies and each semiconductor die is packaged. However, example embodiments are not limited to forming driving circuits on a semiconductor die. Example embodiments may incorporate other substrates commonly used to form display driving circuits. Further, other circuit units or circuit elements typically associated with display driving circuits may be included on the substrate. The semiconductor die 90 of the display driving circuit 1000 may include a first side S1 and a second side S2. The first side S1 may be substantially parallel to a first direction. The second side S2 may be substantially parallel to a second direction that is different from the first direction. For example, the second direction may be substantially perpendicular to the first direction. A length of the first side S1 may be smaller than a length of the second side S2.

The display driving circuit 1000 illustrated in FIG. 1 may be a data driver (e.g., a source driver) for driving a liquid crystal display (LCD) panel. Hereinafter, the display driving circuit according to example embodiments will be described based on the data driver included in a LCD device. However, the display driving circuit according to example embodiments may be a driver for driving various display panels, such as a light emitting diode (LED) display panel, an organic LED (OLED) display panel, a field emission display (FED) panel, etc.

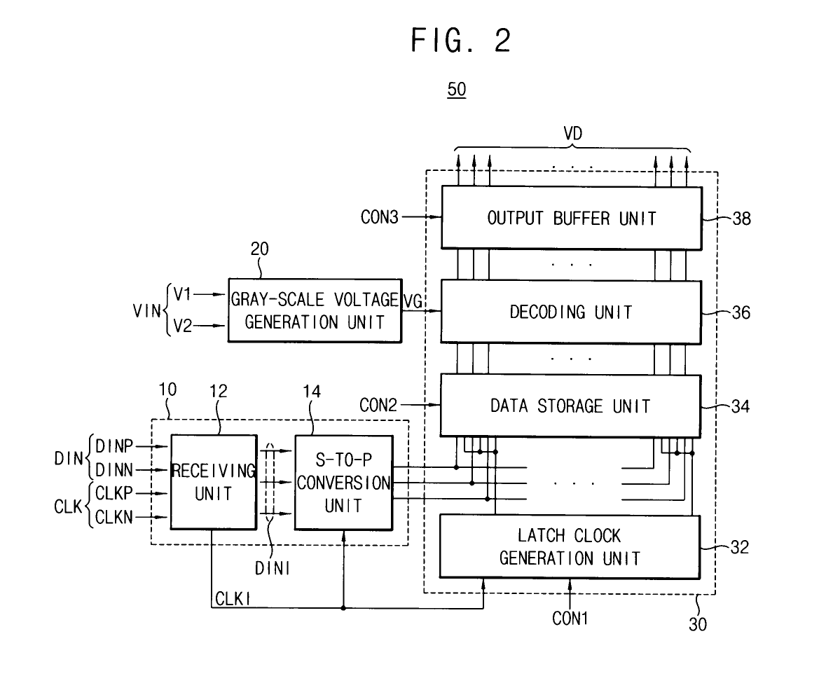

The logic control unit 100 is formed in a central region of the semiconductor die 90. The logic control unit 100 controls the display driving circuit 1000 based on a control signal. The logic control unit 100 may receive the control signal from an external device (not illustrated), such as a controller, a graphic processing unit (GPU), etc., through the signal input pad unit 500. The control signal may include a clock signal, a polarity selection signal, a vertical line start signal, a horizontal line start signal, a data transmission direction control signal, etc. As will be described below with reference to FIG. 2, the logic control unit 100 may include a receiving unit and a data conversion unit.

The gray-scale voltage generation units 200a and 200b are formed in an edge region of the semiconductor die 90. The gray-scale voltage generation units 200a and 200b generate a plurality of gray-scale voltages based on an input voltage. The gray-scale voltage generation units 200a and 200b may receive the input voltage from an external device (not illustrated), such as a power supply device, through the voltage input pad unit 400. However, the voltage generation units 200a and 200b are not limited to generating gray-scale voltages, and may generate any type of voltage used in display drivers.

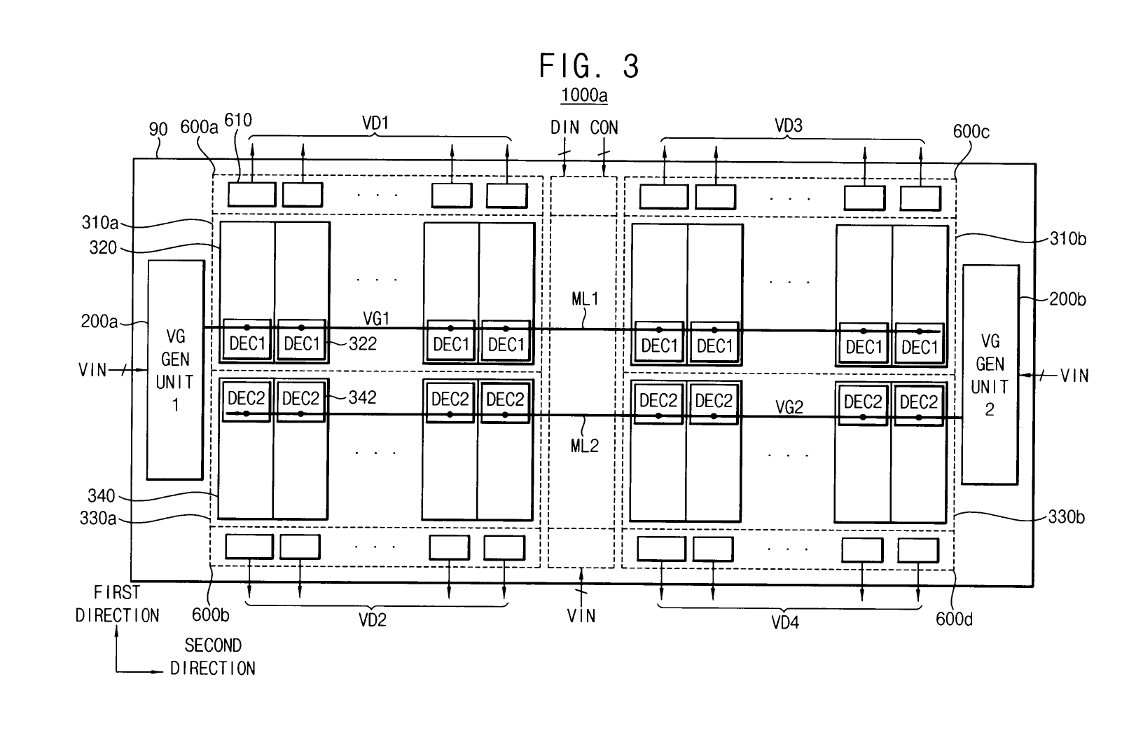

The driving units 300a and 300b are formed in a region of the semiconductor die 90 between the logic control unit 100 and the gray-scale voltage generation units 200a and 200b. The driving units 300a and 300b generate a plurality of driving voltages based on the plurality of gray-scale voltages and input data. The driving units 300a and 300b may receive the control signal from the external device, such as the controller or the GPU, through the signal input pad unit 500. As will be described below with reference to FIGS. 3, 8, 10, 11 and 13, the driving units 300a and 300b may include a plurality of driver cells that are arranged in a matrix of at least one row and a plurality of columns.

In at least one example embodiment, the gray-scale voltage generation units 200a and 200b may include a first gray-scale voltage generation unit 200a and a second gray-scale voltage generation unit 200b. The first gray-scale voltage generation unit 200a may be formed adjacent to the first side 51 of the semiconductor die 90, and may be formed in the first direction along the first side 51 of the semiconductor die 90. The second gray-scale voltage generation unit 200b may be formed adjacent to a third side S3 of the semiconductor die 90, and may be formed in the first direction along the third side S3 of the semiconductor die 90. The third side S3 may correspond to the first side 51. For example, the third side S3 may be substantially parallel to the first side S1.

The driving units 300a and 300b may include a first driving unit 300a and a second driving unit 300b. The first driving unit 300a may be formed in a first region of the semiconductor die 90 between the logic control unit 100 and the first gray-scale voltage generation unit 200a. The second driving unit 300b may be formed in a second region of the semiconductor die 90 between the logic control unit 100 and the second gray-scale voltage generation unit 200b.

In at least one example embodiment, a layout for the second gray-scale voltage generation unit 200b and the second driving unit 300b may be obtained by mirroring a layout for the gray-scale voltage generation unit 200a and the first driving unit 300a such that the two layouts are symmetric with respect to a vertical center line. In another example embodiment, the layout for the second gray-scale voltage generation unit 200b and the second driving unit 300b may be obtained by shifting the layout for the gray-scale voltage generation unit 200a and the first driving unit 300a such that the two layouts may be identically arranged. As such, once a layout for one gray-scale voltage generation unit and one driving unit is designed, the entire layout for the display driving circuit 1000 may be obtained by mirroring and/or shifting the designed layout.

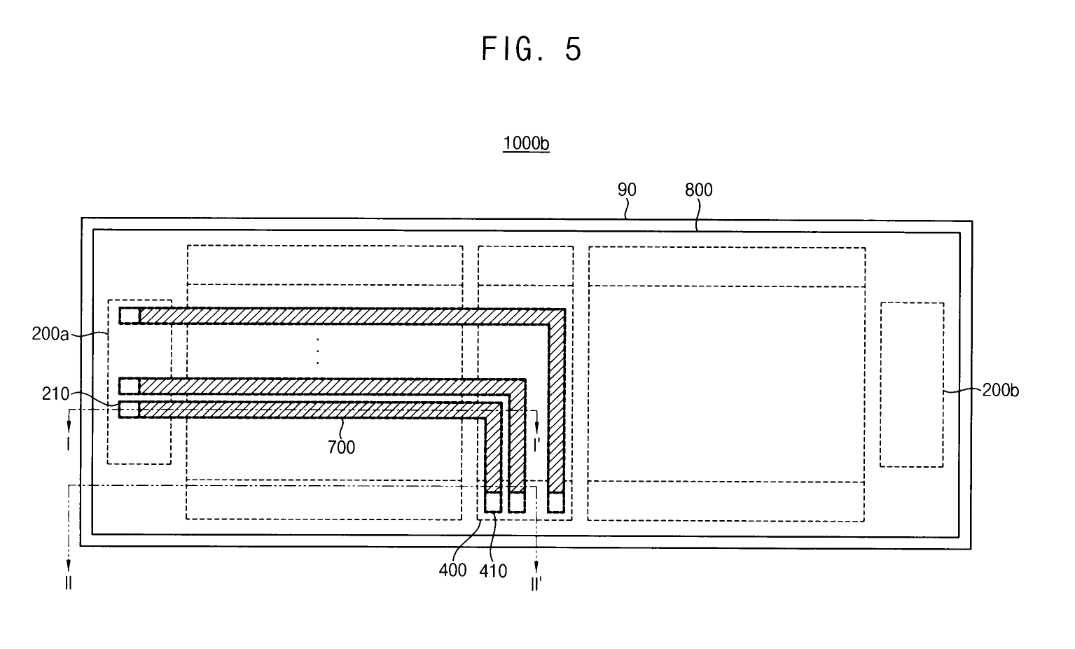

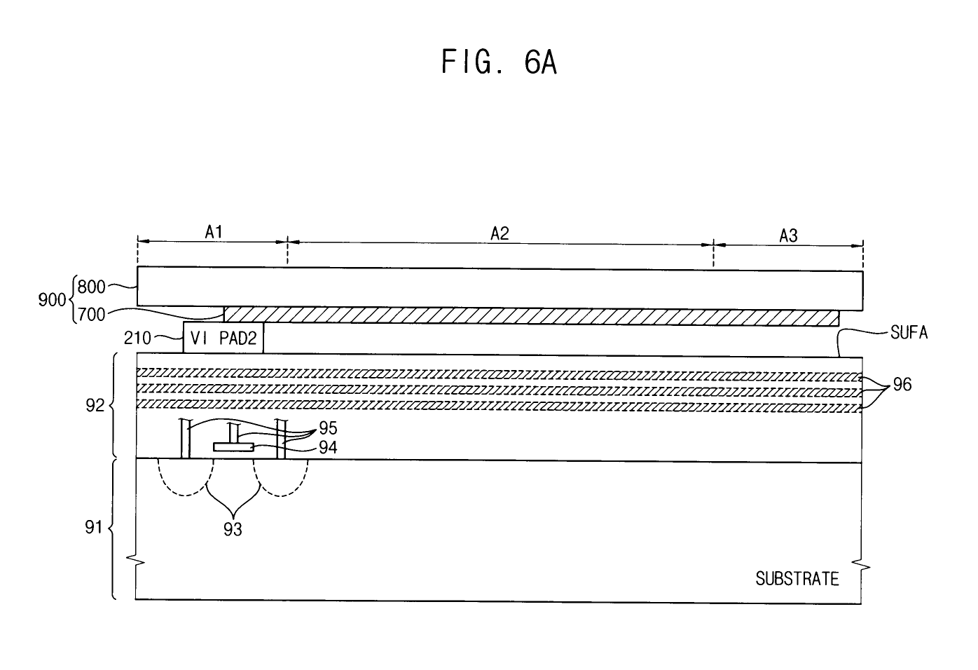

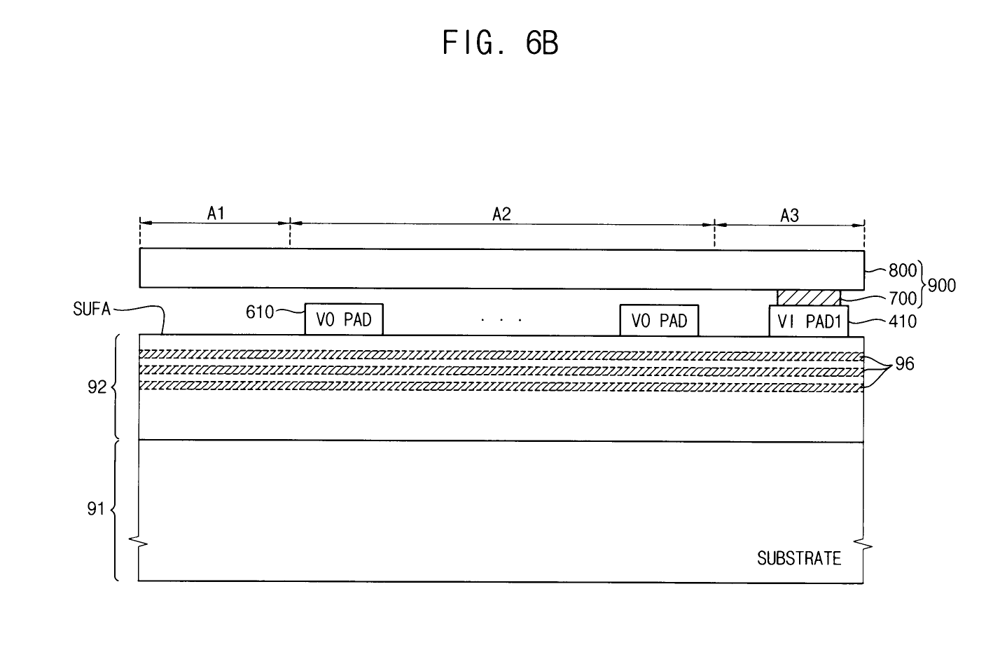

The voltage input pad unit 400 may receive the input voltage. The voltage input pad unit 400 may include a plurality of voltage input pads that are disposed on the semiconductor die 90 along the second direction. As will be described below with reference to FIGS. 5, 6a and 6b, the plurality of voltage input pads may be formed on an active surface of the semiconductor die 90, and the input voltage may be supplied to the gray-scale voltage generation units 200a and 200b through a metal wire layer that is formed above the active surface of the semiconductor die 90, which may be referred to as a film lead routing (FLR) scheme.

The signal input pad unit 500 may receive the control signal and the input data. The signal input pad unit 500 may include a plurality of signal input pads that are disposed along the second direction. The voltage output pad units 600a, 600b, 600c and 600d may output the plurality of driving voltages. Each of the voltage output pad units 600a, 600b, 600c and 600d may include a plurality of voltage output pads that are disposed along the second direction.

In a conventional display driving circuit, a gray-scale voltage generation unit has been included in a logic control unit. In other words, in a layout for the conventional display driving circuit, the gray-scale voltage generation unit has been formed in a central region of a semiconductor die. Thus, the conventional display driving circuit has a relatively large size.

The display driving circuit 1000 according to example embodiments may have a relatively small size by modifying a layout for the gray-scale voltage generation units 200a and 200b. For example, the gray-scale voltage generation units 200a and 200b may not be formed in the central region of the semiconductor die 90, but may be formed in the edge region of the semiconductor die 90, which is not used in the conventional display driving circuit. The gray-scale voltage generation units 200a and 200b may be formed adjacent to short sides (e.g., the first side S1 and the third side S3) of the semiconductor die 90, respectively. The logic control unit 100, which is formed in the central region of the semiconductor die 90, may include at least one of other elements that are not included in the logic control unit of the conventional display driving circuit, and/or may have a relatively small size without including the gray-scale voltage generation units 200a and 200b. Thus, the display driving circuit 1000 may have a relatively small size.

FIG. 2 is a block diagram for describing an operation of the display driving circuit of FIG. 1.

Referring to FIG. 2, a display driving circuit 50 includes a logic control unit 10, a gray-scale voltage generation unit 20 and a driving unit 30.

The logic control unit 10 includes a receiving unit 12 and a serial-to-parallel (S-to-P) conversion unit 14. The logic control unit 10 may correspond to the logic control unit 100 in FIG. 1.

The receiving unit 12 may receive input data DIN and a clock signal CLK that are provided from the external device (e.g., controller, GPU, etc.). The input data DIN may correspond to an image that is displayed on a display panel (not illustrated). The input data DIN and the clock signal CLK may be transmitted by a reduced swing differential signaling (RSDS) interface, which transmits signals with a reduced swing size. In at least one example embodiment, the input data DIN may include first input data DINP and second input data DINN that are a pair of differential data, and the clock signal CLK may include a first clock signal CLKP and a second clock signal CLKN that are a pair of differential signals. The receiving unit 12 may compare the first input data DINP with the second input data DINN to generate internal data DINI, and may compare the first clock signal CLKP with the second clock signal CLKN to generate an internal clock signal CLKI. Although not illustrated in FIG. 2, the receiving unit 12 may include a RSDS receiver and a comparison block.

The S-to-P conversion unit 14 may receive the internal data DINI. The internal data DINI may be stored in parallel in the S-to-P conversion unit 14, and the S-to-P conversion unit 14 may provide the parallel data to the driving unit 30. For example, the S-to-P conversion unit 14 may synchronize the internal data DINI in response to at least one edge of a rising edge and a falling edge of the internal clock signal CLKI, and may output the parallel data. Although not illustrated in FIG. 2, the S-to-P conversion unit 14 may include a plurality of data registers.

The gray-scale voltage generation unit 20 may correspond to the gray-scale voltage generation units 200a and 200b in FIG. 1. The gray-scale voltage generation unit 20 may generate a plurality of gray-scale voltages VG based on an input voltage VIN. For example, the input voltage VIN may include a first voltage V1 (e.g., a power supply voltage) and a second voltage V2 (e.g., a ground voltage) that has lower level than a level of the first voltage V1. The gray-scale voltage generation unit 20 may generate the plurality of gray-scale voltages VG by performing voltage divisions between the first voltage V1 and the second voltage V2. Although not illustrated in FIG. 2, the gray-scale voltage generation unit 20 may include a voltage division unit that has a plurality of resistors connected in series between the first voltage V1 and the second voltage V2.

The driving unit 30 includes a latch clock generation unit 32, a data storage unit 34, a decoding unit 36 and an output buffer unit 38. The driving unit 30 may correspond to the driving units 300a and 300b in FIG. 1.

The latch clock generation unit 32 may generate a plurality of latch clock signals based on the internal clock signal CLKI and a first control signal CON1. The plurality of latch clock signals may be sequentially activated per a desired (or alternatively, predetermined) cycle. The first control signal CON1 may include a signal for notifying an operation point of time (e.g., a horizontal line start signal) and a signal for controlling a data transmission direction (e.g., a data transmission direction control signal). Although not illustrated in FIG. 2, the latch clock generation unit 32 may include a plurality of shift registers.

The data storage unit 34 may generate latched data by latching the parallel data provided from the S-to-P conversion unit 14 based on the plurality of latch clock signals and a second control signal CON2, may store the latched data, and may provide the latched data to the decoding unit 36. The second control signal CON2 may include a signal for displaying the image corresponding to the input data DIN on the display panel in line (e.g., a vertical line start signal). Although not illustrated in FIG. 2, the data storage unit 34 may include a plurality of data latches.

The decoding unit 36 may select at least one of the plurality of gray-scale voltages VG based on the latched data. The output buffer unit 38 may generate a plurality of driving voltages VD by buffering the selected gray-scale voltage based on a third control signal CON3. The third control signal CON3 may include a signal for selecting polarities of the driving voltages VD to have positive or negative voltage levels (e.g., a polarity selection signal). Although not illustrated in FIG. 2, the decoding unit 36 may include a plurality of decoders, and the output buffer unit 38 may include a plurality of buffers (e.g., a plurality of amplifiers). The plurality of driving voltages VD may be applied to data lines of the display panel. The image corresponding to the input data DIN and the driving voltages VD may be displayed on the display panel.

Although not illustrated in FIG. 2, the driving unit 30 may further include a level shifting unit. The level shifting unit may shift levels of the latched data to provide the level-shifted data to the decoding unit 36. The level shifting unit may include a plurality of level shifters.

FIG. 3 is a diagram illustrating an example embodiment of a layout for the display driving circuit of FIG. 1.

Referring to FIG. 3, a display driving circuit 1000a includes a semiconductor die 90, gray-scale voltage generation units 200a and 200b, driving units 310a, 310b, 330a and 330b, and voltage output pad units 600a, 600b, 600c and 600d. For convenience of illustration, a logic control unit, a voltage input pad unit and a signal input pad unit are represented by dashed-lines in a central region of the semiconductor die 90.

The gray-scale voltage generation units may be formed in edge regions of the semiconductor die 90, and may include a first gray-scale voltage generation unit 200a and a second gray-scale voltage generation unit 200b. The first gray-scale voltage generation unit 200a may generate first gray-scale voltages VG1 of the plurality of gray-scale voltages based on an input voltage VIN. The second gray-scale voltage generation unit 200b may generate second gray-scale voltages VG2 of the plurality of gray-scale voltages based on the input voltage VIN. Levels of the first gray-scale voltages VG1 may be lower than levels of the second gray-scale voltages VG2. The display driving circuit 1000a may receive the input voltage VIN through the voltage input pad unit, and the input voltage VIN may be supplied to the gray-scale voltage generation units 200a and 200b by using FLR scheme. The display driving circuit 1000a may receive input data DIN and a control signal CON through the signal input pad unit.

The driving units may include a first driving unit 310a and 330a and a second driving unit 310b and 330b. The first and second driving units 310a, 330a, 310b and 330b may include a plurality of driver cells 320 and 340 that are disposed along the second direction. The voltage output pad units 600a, 600b, 600c and 600d may output the plurality of driving voltages VD1, VD2, VD3 and VD4 that are generated from the plurality of driver cells 320 and 340. Each voltage output pad unit may include a plurality of voltage output pads 610 that are disposed along the second direction.

The plurality of driver cells 320 and 340 may include first driver cells 320 and second driver cells 340. Each first driver cell 320 may include a first decoder 322 that selects one of the first gray-scale voltages VG1. Each second driver cell 340 may include a second decoder 342 that selects one of the second gray-scale voltages VG2. For example, the first decoder 322 may be a n-type decoder that is implemented with n-type transistors, and the second decoder 342 may be a p-type decoder that is implemented with p-type transistors. The first and second decoders 322 and 342 may correspond to the decoding unit 36 in FIG. 2.

In at least one example embodiment, the display driving circuit 1000a may further include a first metal wire ML1 and a second metal wire ML2. The first metal wire ML1 may supply the first gray-scale voltages VG1 to the first decoders 322. The second metal wire ML2 may supply the second gray-scale voltages VG2 to the second decoders 342. As will be described below with reference to FIGS. 6A and 6B, the semiconductor die 90 may include a substrate region and an upper region, and the metal wires ML1 and ML2 may be formed in the upper region of the semiconductor die 90. Although not illustrated in FIG. 3, three metal wires may be used in the central region (e.g., in the logic control unit) of the semiconductor die 90 for supplying the gray-scale voltages VG1 and VG2.

In FIG. 3, the display driving circuit 1000a may have a double row architecture of the plurality of driver cells 320 and 340. The double row architecture may include a configuration where two driver cells are arranged to be symmetric with respect to a horizontal center line. In FIG. 3, driver cells in the same row may be of the same type. For example, the first driver cells 320 may be disposed in first rows 310a and 310b of the driving unit along the second direction, and the second driver cells 340 may be disposed in second rows 330a and 330b of the driving unit along the second direction. Similarly, the first decoders 322 may be disposed in first rows 310a and 310b, and the second decoders 342 may be disposed in second rows 330a and 330b. The second rows 330a and 330b may be adjacent to the first rows 310a and 310b in the first direction. Therefore, a driver cell in the first rows 310a and 310b may be symmetric to a corresponding driver cell in the second rows 330a and 330b.

In the display driving circuit 1000a according to some example embodiments, the logic control unit may have a relatively small size by modifying the layout for the gray-scale voltage generation units 200a and 200b (e.g., by forming the gray-scale voltage generation units 200a and 200b in the edge regions of the semiconductor die 90). Pitches of the driver cells 320 and 340 may be reduced since the display driving circuit 1000a has the double row architecture of the plurality of driver cells 320 and 340. Thus, the display driving circuit 1000a may have a relatively small size. In addition, the gray-scale voltages VG1 and VG2 may be effectively applied to all decoders 322 and 342 through two metal wires ML1 and ML2 since the driver cells in the same row are of the same type. Thus, the display driving circuit 1000a may have a relatively enhanced performance of transmitting a signal (e.g., a voltage).

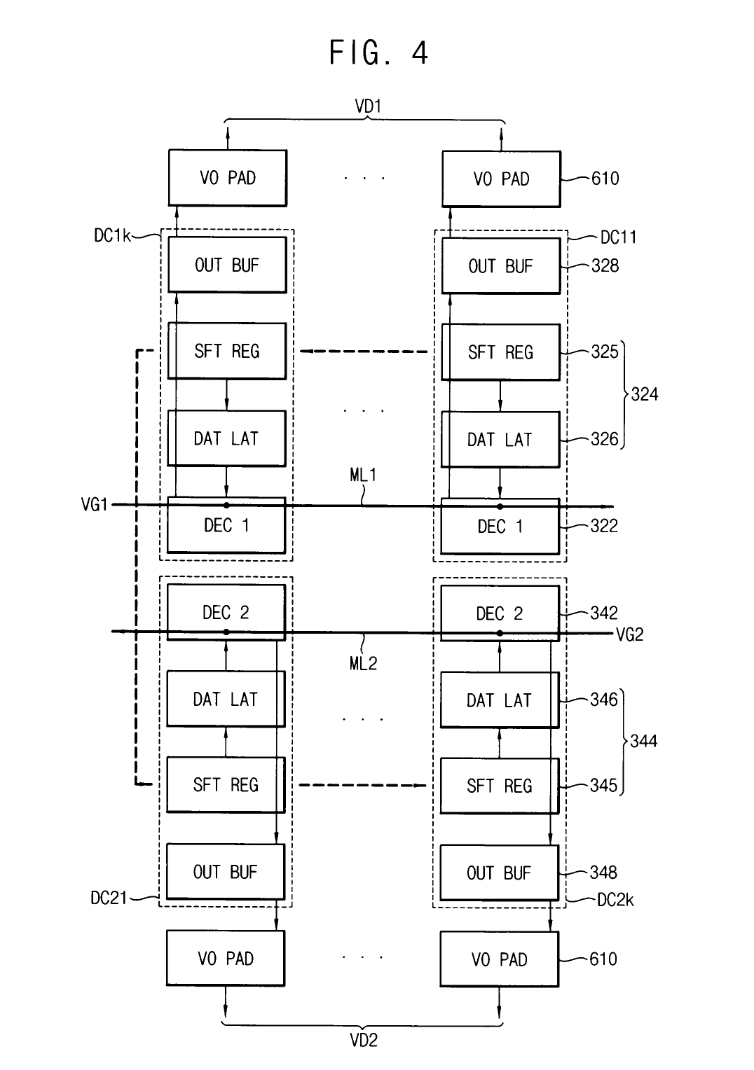

FIG. 4 is a block diagram describing an operation of the display driving circuit of FIG. 3. FIG. 4 illustrates example configurations of the first driving unit 310a and 330a and the voltage output pad units 600a and 600b.

Referring to FIGS. 3 and 4, first driver cells DC11, . . . , DC1k may be disposed in the first row 310a of the first driving unit. Second driver cells DC21, . . . , DC2k may be disposed in the second row 330a of the first driving unit. Each driver cell may include a data transmission unit, a decoder corresponding to the decoding unit 36 in FIG. 2, and an output buffer corresponding to the output buffer unit 38 in FIG. 2. The data transmission unit may include a shift register corresponding to the latch clock generation unit 32 in FIG. 2, and a data latch corresponding to the data storage unit 34 in FIG. 2. The data transmission unit may further include a level shifter (not illustrated). For example, a first driver cell DC11 may include a first data transmission unit 324, a first decoder 322 and a first output buffer 328. The first data transmission unit 324 may include a first shift register 325 and a first data latch 326. A second driver cell DC2k may include a second data transmission unit 344, a second decoder 342 and a second output buffer 348. The second data transmission unit 344 may include a second shift register 345 and a second data latch 346.

As described above with reference to FIG. 2, the first shift register 325 may generate a first latch clock signal based on the control signal CON (e.g., the first control signal CON1). The first data latch 326 may generate first latched data by latching first data of the input data DIN (e.g., the parallel data) based on the first latch clock signal. The first data may correspond to a first data line of the display panel. A shift register included in a next driver cell may generate a second latch clock signal having a shifted pulse based on the control signal CON. A data latch included in the next driver cell may generate second latched data by latching second data of the input data DIN based on the second latch clock signal. The second data may correspond to a second data line of the display panel. In other words, a shift register located at a later stage may generate a latch clock signal having a pulse with a greater shift (e.g., delay) than a shift register located at an earlier stage. Data latches 326 and 346 may sequentially generate the latched data by latching corresponding data of the input data DIN based on a corresponding latch clock signal. As illustrated in FIG. 4 by a dashed-arrow, such shifting and latching operations may be sequentially performed by the shift registers 325 and the data latches 326 disposed in the first row 310a of the first driving unit, and then by the shift registers 345 and the data latches 346 disposed in the second row 330a of the first driving unit.

After the entire input data DIN corresponding to the entire data lines of the display panel is sequentially latched, the latched data may be transmitted to the decoders 322 and 342. Each decoder may select one of the plurality of gray-scale voltages VG1 and VG2 based on a corresponding latched data. Each output buffer may generate one of the plurality of driving voltages VD1 and VD2 by buffering the selected gray-scale voltage. The voltage output pads 610 may output the plurality of driving voltages VD1 and VD2.

FIG. 5 is a diagram illustrating another example embodiment of a layout for the display driving circuit of FIG. 1. FIGS. 6A and 6B are diagrams describing the layout for the display driving circuit of FIG. 5.

FIG. 6A is a cross-sectional view of the display driving circuit of FIG. 5 cut along the line I-I′. FIG. 6B is a cross-sectional view of the display driving circuit of FIG. 5 cut along the line II-II′. FIGS. 6A and 6B schematically illustrate the vertical structure of a semiconductor die 90 and a plurality of metal wire patterns 700 with respect to an area A1 for the gray-scale voltage generation unit, an area A2 for the driving unit and an area A3 for the logic control unit. The structural elements shown in FIGS. 6A and 6B may be formed using semiconductor processes such as depositing, etching, doping, patterning, sputtering, etc.

Referring to FIGS. 5, 6A and 6B, a display driving circuit 1000b includes the semiconductor die 90, gray-scale voltage generation units 200a and 200b, and a voltage input pad unit 400. For convenience of illustration, a logic control unit, driving units, a signal input pad unit and voltage output pad units are represented by dashed-lines in FIG. 5.

The semiconductor die 90 may include a substrate region 91 and an upper region 92. Active regions 93 for a source and a drain of a transistor may be formed in the upper portion of the substrate region 91 through ion-implanting process, and a gate 94 of the transistor may be formed in the upper region 92. Although not illustrated in FIG. 6A, the passive elements such as MOS capacitor may be formed in the substrate region 91 and the upper region 92. The upper region 92 may include metal layers in which metal lines 96 for signal routing and power supplying are formed. For example, the metal wires ML1 and ML2 in FIG. 3 may be formed in the upper region 92.

The voltage input pad unit 400 may include a plurality of first voltage input pads 410, and the gray-scale voltage generation units 200a and 200b may include a plurality of second voltage input pads 210. The voltage output pad units may include a plurality of voltage output pads 610. The first and second voltage input pads 410 and 210 and the voltage output pads 610 may be formed on an active surface SUFA of the semiconductor die 90. The active surface SUFA may be an upper surface of the semiconductor die 90. The electrodes of the transistor 93 and 94, the metal lines 96 in the metal layers, and the pads 210, 410 and 610 may be electrically connected through inter-layer connections 95 such as via holes.

The display driving circuit 1000b may further include a metal wire layer 900 formed above the active surface SUFA of the semiconductor die 90. The metal wire layer 900 may be formed by using FLR scheme, and may include the plurality of metal wire patterns 700 and an insulation layer 800.

The display driving circuit 1000b may receive the input voltage VIN through the first voltage input pads 410. The input voltage VIN may be supplied to the second voltage input pads 210 through the metal wire patterns 700 that are formed above the active surface SUFA of the semiconductor die 90. In other words, the metal wire patterns 700 may electrically connect the first voltage input pads 410 to the second voltage input pads 210, and may electrically connect the voltage input pad unit 400 to the gray-scale voltage generation units 200a and 200b. The metal wire patterns 700 may include lead patterns.

The insulation layer 800 may be formed on the plurality of metal wire patterns 700, and may protect the plurality of metal wire patterns 700. For example, the insulation layer 800 may cover the logic control unit, the gray-scale voltage generation units 200a and 200b and the driving unit, and may not cover some portion of the voltage output pads 610. In other words, some portion of the voltage output pads 610 may be exposed.

The metal wire layer 900 may be implemented as a film-type of interconnection substrate. The insulation layer 800 may be a base film, and may include polyimide material. The plurality of metal wire patterns 700 may be supported by the insulation layer 800. In at least one example embodiment, the metal wire patterns 700 may be formed on the insulation layer 800, the structure including the metal wire patterns 700 and the insulation layer 800 may be overturned, the overturned structure may be stacked above the active surface SUFA, and the metal wire layer 900 may be formed above the active surface SUFA of the semiconductor die 90. In another example embodiment, the metal wire patterns 700 may be formed above the active surface SUFA, the insulation layer 800 may be formed on the metal wire patterns 700, and the metal wire layer 900 may be formed above the active surface SUFA of the semiconductor die 90.

Although not illustrated in FIGS. 6A and 6B, conductive bumps may be formed between the voltage input pads 210 and 410 and the metal wire patterns 700. For example, the conductive bumps may be formed on the voltage input pads 210 and 410 using ball-drop process, screen printing process, etc. The electrical contact between the conductive bumps and the voltage input pads 210 and 410 may be enhanced by reflowing the conductive bumps over a melting point. Although not illustrated in FIGS. 6A and 6B, additional insulation layer may be formed between the semiconductor die 90 and the metal wire layer 900.

In the display driving circuit 1000b according to example embodiments, the logic control unit may have a relatively small size by modifying the layout for the gray-scale voltage generation units 200a and 200b (e.g., by forming the gray-scale voltage generation units 200a and 200b in the edge regions of the semiconductor die 90). Thus, the display driving circuit 1000b may have a relatively small size. In addition, the metal wire layer 900 that supplies the input voltage VIN to the gray-scale voltage generation units 200a and 200b may be formed above the active surface SUFA of the semiconductor die 90. Thus, the input voltage VIN may be effectively supplied to the gray-scale voltage generation units 200a and 200b without modifying a layout for metal lines of the display driving circuit 1000b.

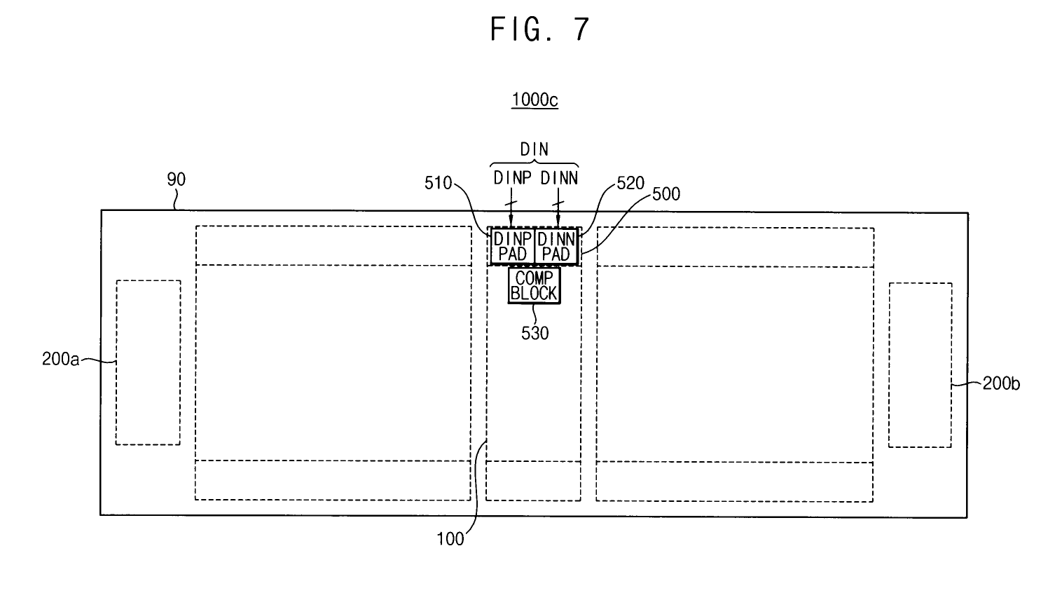

FIG. 7 is a diagram illustrating still another example embodiment of a layout for the display driving circuit of FIG. 1.

Referring to FIG. 7, a display driving circuit 1000c includes the semiconductor die 90, a logic control unit 100, gray-scale voltage generation units 200a and 200b, and a signal input pad unit 500. For convenience of illustration, driving units, a voltage input pad unit and voltage output pad units are represented by dashed-lines in FIG. 7.

The signal input pad unit 500 may receive the input data DIN, and may include a plurality of signal input pads 510 and 520. The input data DIN may include first input data DINP and second input data DINN that are a pair of differential data. The plurality of signal input pads may include a first signal input pad 510 that receives the first input data DINP and a second signal input pad 520 that receives the second input data DINN.

The logic control unit 100 may include a comparison block 530. The comparison block 530 may compare the first input data DINP with the second input data DINN to generate internal data that is used in the display driving circuit 1000c. Although not illustrated in FIG. 7, the logic control unit 100 may include additional elements, such as a data conversion unit, etc.

Although not illustrated in FIG. 7, the signal input pad unit 500 may further receive the control signal CON (e.g., a clock signal). The clock signal may include a first clock signal and a second clock signal that are a pair of differential signals. In this case, the signal input pad unit 500 may further include a third signal input pad that receives the first clock signal and a fourth signal input pad that receives the second clock signal, and the logic control unit 100 may further include a second comparison block that compares the first clock signal with the second clock signal to generate an internal clock signal.

In a conventional display driving circuit, a comparison block may be included in a signal input pad unit with a plurality of signal input pads. Thus, the signal input pad unit in the conventional display driving circuit has a relatively large size, and the conventional display driving circuit has a relatively large size.

In the display driving circuit 1000c according to still other example embodiments, the gray-scale voltage generation units 200a and 200b may be formed in the edge regions of the semiconductor die 90, and the comparison block 530 may be disposed in the logic control unit 100. The logic control unit 100 may further include at least one of other elements that are not included in the logic control unit of a conventional display driving circuit. Thus, the display driving circuit 1000c according to example embodiments may have a relatively small size.

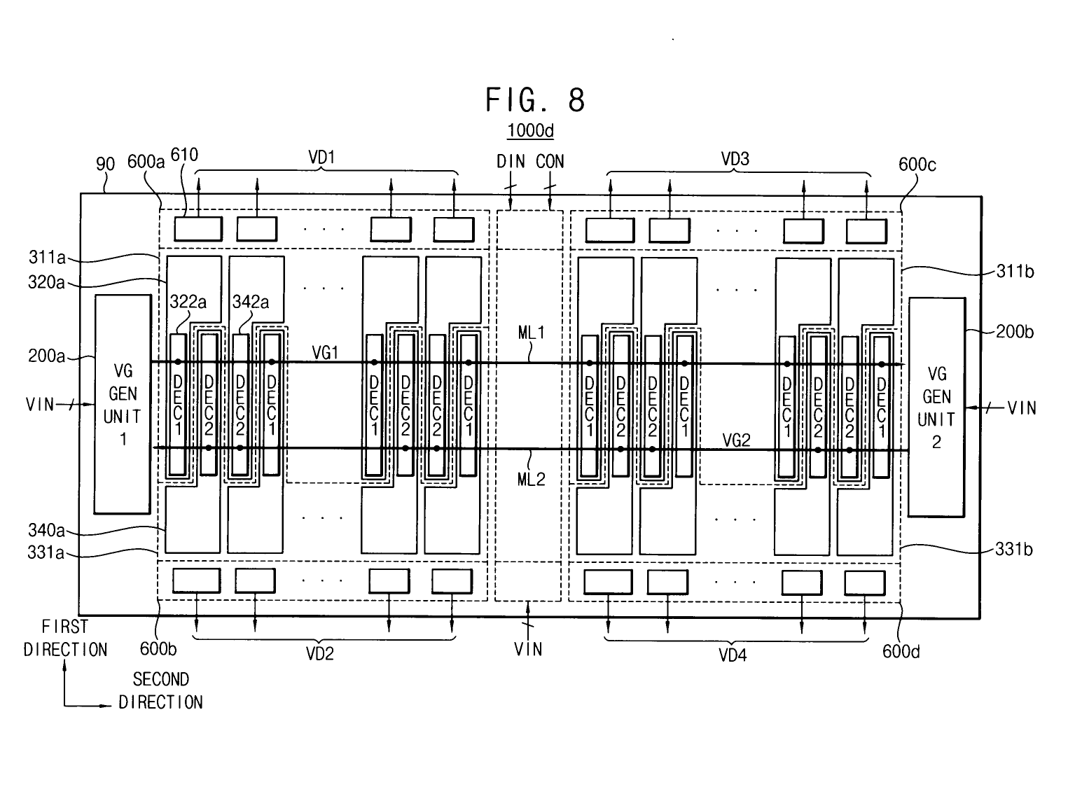

FIG. 8 is a diagram illustrating still another example embodiment of a layout for the display driving circuit of FIG. 1.

Referring to FIG. 8, a display driving circuit 1000d includes a semiconductor die 90, gray-scale voltage generation units 200a and 200b, driving units 311a, 311b, 331a and 331b, and voltage output pad units 600a, 600b, 600c and 600d. For convenience of illustration, a logic control unit, a voltage input pad unit and a signal input pad unit are represented by dashed-lines in a central region of the semiconductor die 90.

The gray-scale voltage generation units may be formed in edge regions of the semiconductor die 90, and may include a first gray-scale voltage generation unit 200a and a second gray-scale voltage generation unit 200b. The driving units may include a first driving unit 311a and 331a and a second driving unit 311b and 331b. The first and second driving units 311a, 331a, 311b and 331b may include a plurality of driver cells 320a and 340a. The voltage output pad units 600a, 600b, 600c and 600d may include a plurality of voltage output pads 610, and may output the plurality of driving voltages VD1, VD2, VD3 and VD4.

The plurality of driver cells 320a and 340a may include first driver cells 320a and second driver cells 340a. Each first driver cell 320a may include a first decoder 322a that selects one of the first gray-scale voltages VG1. Each second driver cell 340a may include a second decoder 342a that selects one of the second gray-scale voltages VG2. A first metal wire ML1 may supply the first gray-scale voltages VG1 to the first decoders 322a. A second metal wire ML2 may supply the second gray-scale voltages VG2 to the second decoders 342a.

In FIG. 8, the display driving circuit 1000d may have a double row architecture of the plurality of driver cells 320a and 340a, and the first driver cells 320a and the second driver cells 340a may be alternately disposed along the second direction. For example, the first driver cells 320a and the second driver cells 340a may be alternately disposed in first rows 311a and 311b of the driving unit along the second direction, and may be alternately disposed in second rows 331a and 331b of the driving unit along the second direction. Differently from the display driving circuit 1000a of FIG. 3, the display driving circuit 1000d may have a single row architecture of the plurality of decoders 322a and 342a, and the first decoders 322a and the second decoders 342a may be alternately disposed along the second direction.

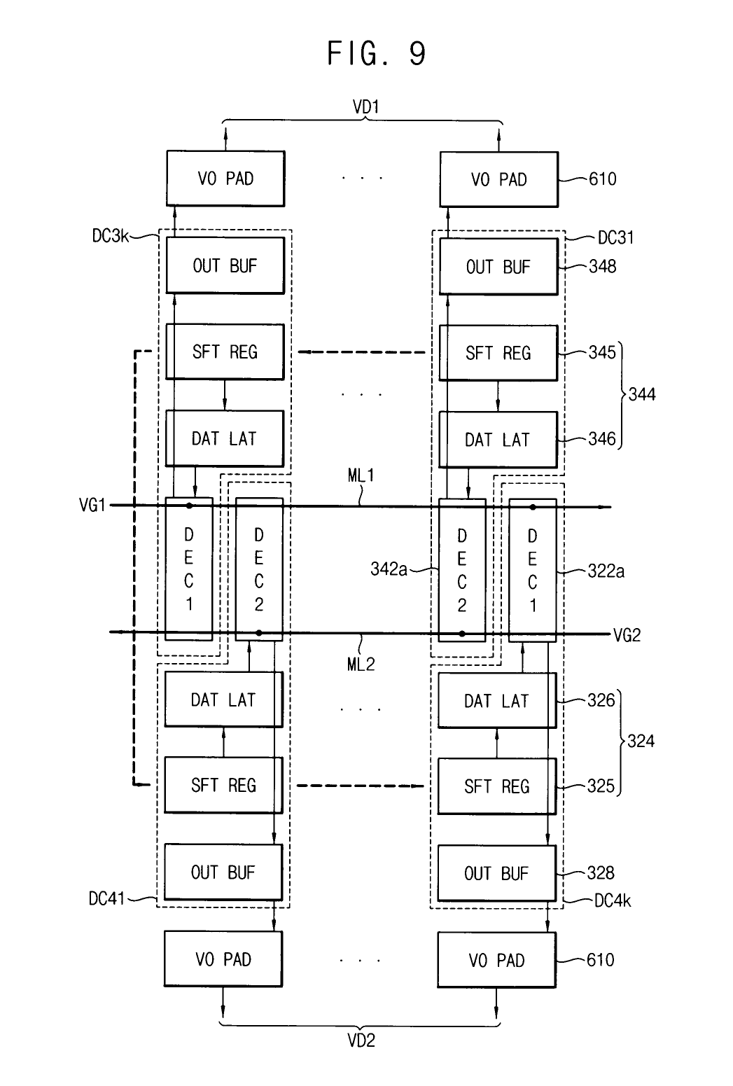

FIG. 9 is a block diagram describing an operation of the display driving circuit of FIG. 8. FIG. 9 illustrates configurations of the first driving unit 311a and 331a and the voltage output pad units 600a and 600b. In comparison with the example embodiment shown in FIG. 4, the plurality of decoders 322a and 342a may be disposed in a single row in an embodiment of FIG. 9.

Referring to FIGS. 8 and 9, driver cells DC31, . . . , DC3k may be disposed in the first row 311a of the first driving unit. Driver cells DC41, . . . , DC4k may be disposed in the second row 331a of the first driving unit. A first driver cell DC4k may include a first data transmission unit 324, a first decoder 322a and a first output buffer 328. The first data transmission unit 324 may include a first shift register 325 and a first data latch 326. A second driver cell DC31 may include a second data transmission unit 344, a second decoder 342a and a second output buffer 348. The second data transmission unit 344 may include a second shift register 345 and a second data latch 346.

Shift registers 325 and 345 may generate latch clock signals that are sequentially activated based on the control signal CON. Data latches 326 and 346 may sequentially generate the latched data by latching corresponding data of input data DIN based on a corresponding latch clock signal. After the entire input data DIN corresponding to the entire data lines of the display panel is sequentially latched, the latched data may be transmitted to the decoders 322a and 342a. Each decoder may select one of the plurality of gray-scale voltages VG1 and VG2 based on a corresponding latched data. Each output buffer may generate one of the plurality of driving voltages VD 1 and VD2 by buffering the selected gray-scale voltage. The voltage output pads 610 may output the plurality of driving voltages VD1 and VD2.

In the display driving circuit 1000d according to example embodiments, the gray-scale voltage generation units 200a and 200b may be formed in the edge regions of the semiconductor die 90. Pitches of the driver cells 320a and 340a may be reduced since the display driving circuit 1000d has the double row architecture of the plurality of driver cells 320a and 340a. Thus, the display driving circuit 1000d may have a relatively small size. In addition, the gray-scale voltages VG1 and VG2 may be effectively applied to all decoders 322a and 342a through two metal wires ML1 and ML2.

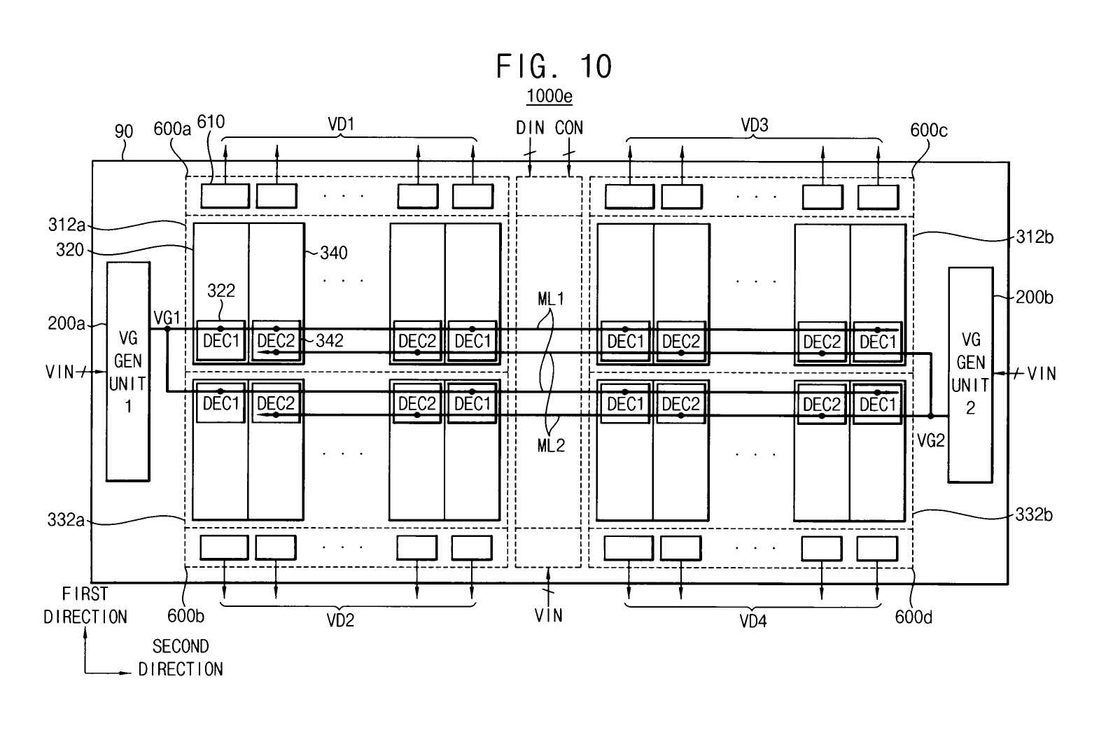

FIG. 10 is a diagram illustrating still another example embodiment of a layout for the display driving circuit of FIG. 1.

Referring to FIG. 10, a display driving circuit 1000e includes a semiconductor die 90, gray-scale voltage generation units 200a and 200b, driving units 312a, 312b, 332a and 332b, and voltage output pad units 600a, 600b, 600c and 600d. For convenience of illustration, a logic control unit, a voltage input pad unit and a signal input pad unit are represented by dashed-lines in a central region of the semiconductor die 90.

The gray-scale voltage generation units may be formed in edge regions of the semiconductor die 90, and may include a first gray-scale voltage generation unit 200a and a second gray-scale voltage generation unit 200b. The driving units may include a first driving unit 312a and 332a and a second driving unit 312b and 332b. The first and second driving units 312a, 332a, 312b and 332b may include a plurality of driver cells 320 and 340. The voltage output pad units 600a, 600b, 600c and 600d may include a plurality of voltage output pads 610, and may output the plurality of driving voltages VD1, VD2, VD3 and VD4.

In FIG. 10, the display driving circuit 1000e may have a double row architecture of the plurality of driver cells 320 and 340, and the first driver cells 320 and the second driver cells 340 may be alternately disposed along the second direction. For example, the first driver cells 320 and the second driver cells 340 may be alternately disposed in first rows of the driving units 312a and 312b along the second direction, and may be alternately disposed in second rows of the driving units 332a and 332b along the second direction. The display driving circuit 1000e may have a double row architecture of the plurality of decoders 322 and 342. Unlike the display driving circuit 1000a of FIG. 3, the first decoders 322 and the second decoders 342 may be alternately disposed along the second direction. A first metal wire ML1 may supply the first gray-scale voltages VG1 to the first decoders 322. A second metal wire ML2 may supply the second gray-scale voltages VG2 to the second decoders 342.

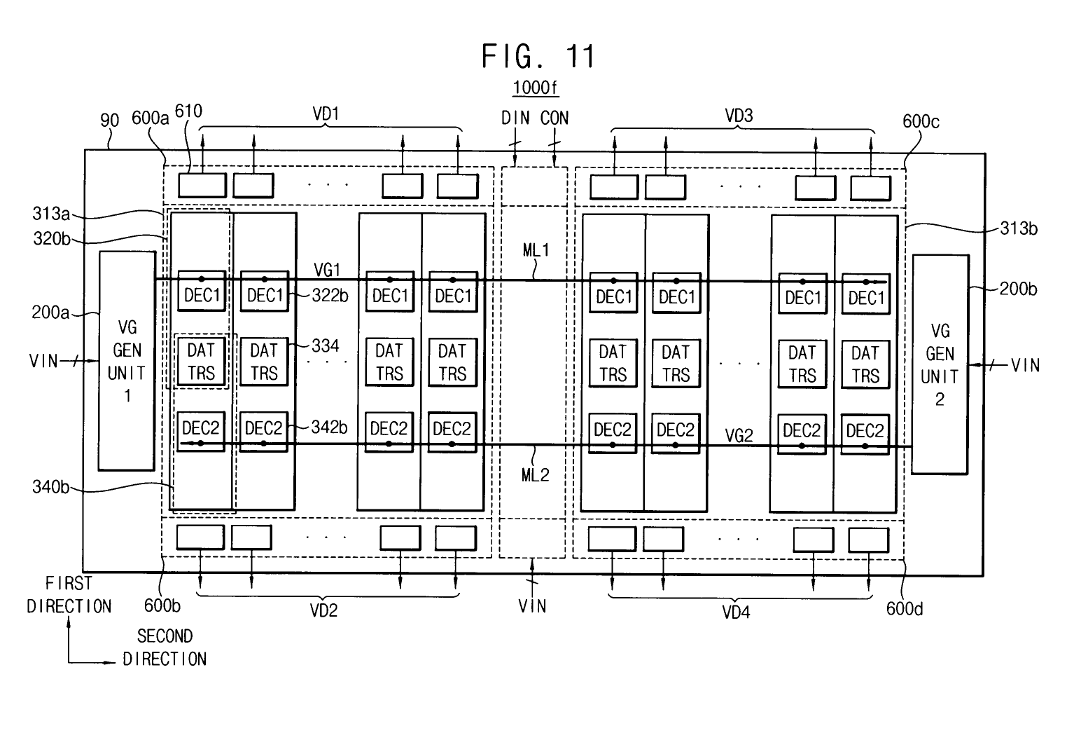

FIG. 11 is a diagram illustrating still another example embodiment of a layout for the display driving circuit of FIG. 1.

Referring to FIG. 11, a display driving circuit 1000f includes a semiconductor die 90, gray-scale voltage generation units 200a and 200b, driving units 313a and 313b, and voltage output pad units 600a, 600b, 600c and 600d. For convenience of illustration, a logic control unit, a voltage input pad unit and a signal input pad unit are represented by dashed-lines in a central region of the semiconductor die 90.

The gray-scale voltage generation units may be formed in edge regions of the semiconductor die 90, and may include a first gray-scale voltage generation unit 200a and a second gray-scale voltage generation unit 200b. The driving units may include a first driving unit 313a and a second driving unit 313b. The first and second driving units 313a and 313b may include a plurality of driver cells 320b and 340b. The voltage output pad units 600a, 600b, 600c and 600d may include a plurality of voltage output pads 610, and may output the plurality of driving voltages VD1, VD2, VD3 and VD4.

The plurality of driver cells 320b and 340b may include first driver cells 320b and second driver cells 340b. Each first driver cell 320b may include a first decoder 322b that selects one of the first gray-scale voltages VG1. Each second driver cell 340b may include a second decoder 342b that selects one of the second gray-scale voltages VG2. A first metal wire ML1 may supply the first gray-scale voltages VG1 to the first decoders 322b. A second metal wire ML2 may supply the second gray-scale voltages VG2 to the second decoders 342b.

In FIG. 11, the display driving circuit 1000f may have a double row architecture of the plurality of driver cells 320b and 340b. Driver cells in the same column may share a data transmission unit 334. For example, the first driver cell 320b disposed in a first row and a first column of the first driving unit 313a and the second driver cell 340b disposed in a second row and a first column of the first driving unit 313a may share the data transmission unit 334. As described above with reference to FIGS. 4 and 9, the data transmission units may be connected in series and may be sequentially driven with similar timing. Thus, when the driver cells in the same column share the data transmission unit, a size of the display driving circuit 1000f may be reduced.

In an example embodiment, driver cells in the same row may be of the same type. For example, as illustrated in FIG. 11, the first driver cells 320b may be disposed in the first row of the driving unit along the second direction, and the second driver cells 340b may be disposed in the second row of the driving unit along the second direction. In another example embodiment, although not illustrated in FIG. 11, the first driver cells 320b and the second driver cells 340b may be alternately disposed along the second direction.

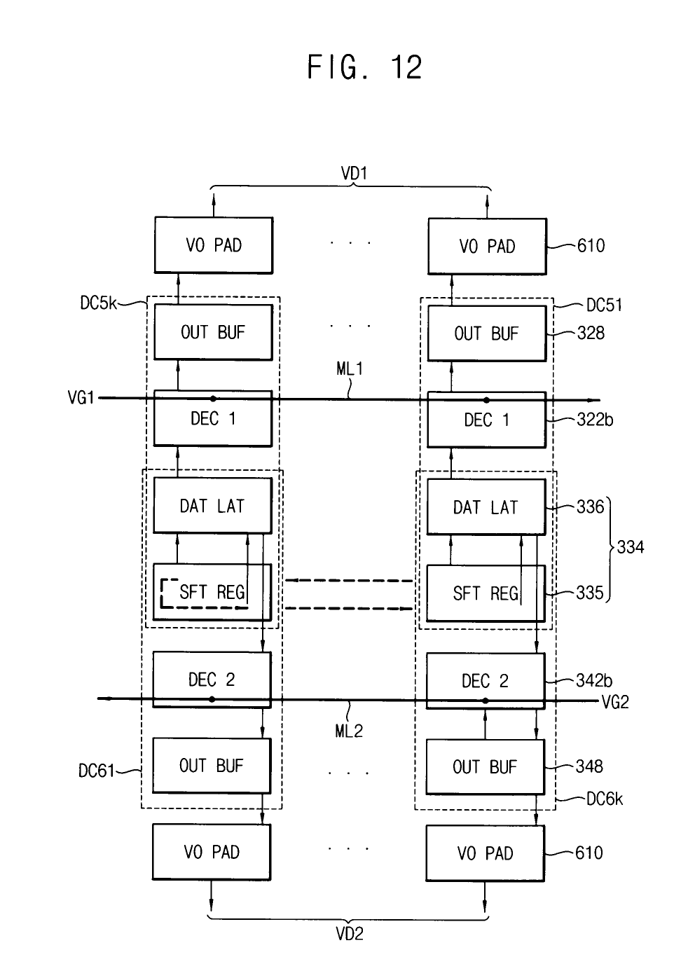

FIG. 12 is a block diagram describing an operation of the display driving circuit of FIG. 11. FIG. 12 illustrates example configurations of the first driving unit 313a and the voltage output pad units 600a and 600b.

Referring to FIGS. 11 and 12, first driver cells DC51, . . . , DC5k may be disposed in the first row of the first driving unit 313a. Second driver cells DC61, . . . , DC6k may be disposed in the second row of the first driving unit 313a. A first driver cell DC51 may include the data transmission unit 334, a first decoder 322b and a first output buffer 328. A second driver cell DC6k may include the data transmission unit 334, a second decoder 342b and a second output buffer 348. Driver cells in the same column (e.g., the first driver cell DC51 and the second driver cell DC6k) may share the data transmission unit 344 that includes a shift register 335 and a data latch 336.

Shift registers 335 may generate latch clock signals that are sequentially activated based on the control signal CON. Data latches 336 may sequentially generate the latched data by latching corresponding data of input data DIN based on a corresponding latch clock signal. As illustrated in FIG. 12 by a dashed-arrow, such shifting and latching operations may be sequentially performed with respect to the first driver cells DC51, . . . , DC5k in the first row of the first driving unit 313a, and the latched data corresponding to the first driver cells DC51, . . . , DC5k may be transmitted to the first decoders 322b. The shifting direction of the shift registers 335 may be changed, and then such shifting and latching operations may be sequentially performed with respect to the second driver cells DC61, . . . , DC6k in the second row of the first driving unit 313a, and the latched data corresponding to the second driver cells DC61, . . . , DC6k may be transmitted to the second decoders 342b. Each decoder may select one of the plurality of gray-scale voltages VG1 and VG2 based on corresponding latched data. Each output buffer may generate one of the plurality of driving voltages VD1 and VD2 by buffering the selected gray-scale voltage. The voltage output pads 610 may output the plurality of driving voltages VD1 and VD2.

In the display driving circuit 1000f according to still other example embodiments, the gray-scale voltage generation units 200a and 200b may be formed in the edge regions of the semiconductor die 90. Pitches of the driver cells 320b and 340b may be reduced since the display driving circuit 1000f has the double row architecture of the plurality of driver cells 320b and 340b. Driver cells in the same column may share the data transmission unit 334. Thus, the display driving circuit 1000f may have a relatively small size. In addition, the gray-scale voltages VG1 and VG2 may be effectively supplied to all decoders 322b and 342b through two metal wires ML1 and ML2.

FIG. 13 is a diagram illustrating still another example embodiment of a layout for the display driving circuit of FIG. 1.

Referring to FIG. 13, a display driving circuit 1000g includes a semiconductor die 90, gray-scale voltage generation units 200a and 200b, driving units 314a and 314b, and voltage output pad units 600a, 600b, 600c and 600d. For convenience of illustration, a logic control unit, a voltage input pad unit and a signal input pad unit are represented by dashed-lines in a central region of the semiconductor die 90.

The gray-scale voltage generation units may be formed in edge regions of the semiconductor die 90, and may include a first gray-scale voltage generation unit 200a and a second gray-scale voltage generation unit 200b. The driving units may include a first driving unit 314a and a second driving unit 314b. The first and second driving units 314a and 314b may include a plurality of driver cells 320c and 340c. The voltage output pad units 600a, 600b, 600c and 600d may include a plurality of voltage output pads 610, and may output the plurality of driving voltages VD1, VD2, VD3 and VD4.

The plurality of driver cells 320c and 340c may include first driver cells 320c and second driver cells 340c. Each first driver cell 320c may include a first decoder 322c that selects one of the first gray-scale voltages VG1. Each second driver cell 340c may include a second decoder 342c that selects one of the second gray-scale voltages VG2. A first metal wire ML1 may supply the first gray-scale voltages VG1 to the first decoders 322c. A second metal wire ML2 may supply the second gray-scale voltages VG2 to the second decoders 342c.

In FIG. 13, the display driving circuit 1000g may have a single row architecture of the plurality of driver cells 320c and 340c, and the first driver cells 320c and the second driver cells 340c may be alternately disposed in the driving units 314a and 314b along the second direction. Similarly, the display driving circuit 1000g may have a single row architecture of the plurality of decoders 322c and 342c, and the first decoders 322c and the second decoders 342c may be alternately disposed along the second direction.

In the display driving circuit 1000g according to some example embodiments, the gray-scale voltage generation units 200a and 200b may be formed in the edge regions of the semiconductor die 90. Thus, the display driving circuit 1000g may have a relatively small size. In addition, the gray-scale voltages VG1 and VG2 may be effectively supplied to all decoders 322c and 342c through two metal wires ML1 and ML2.

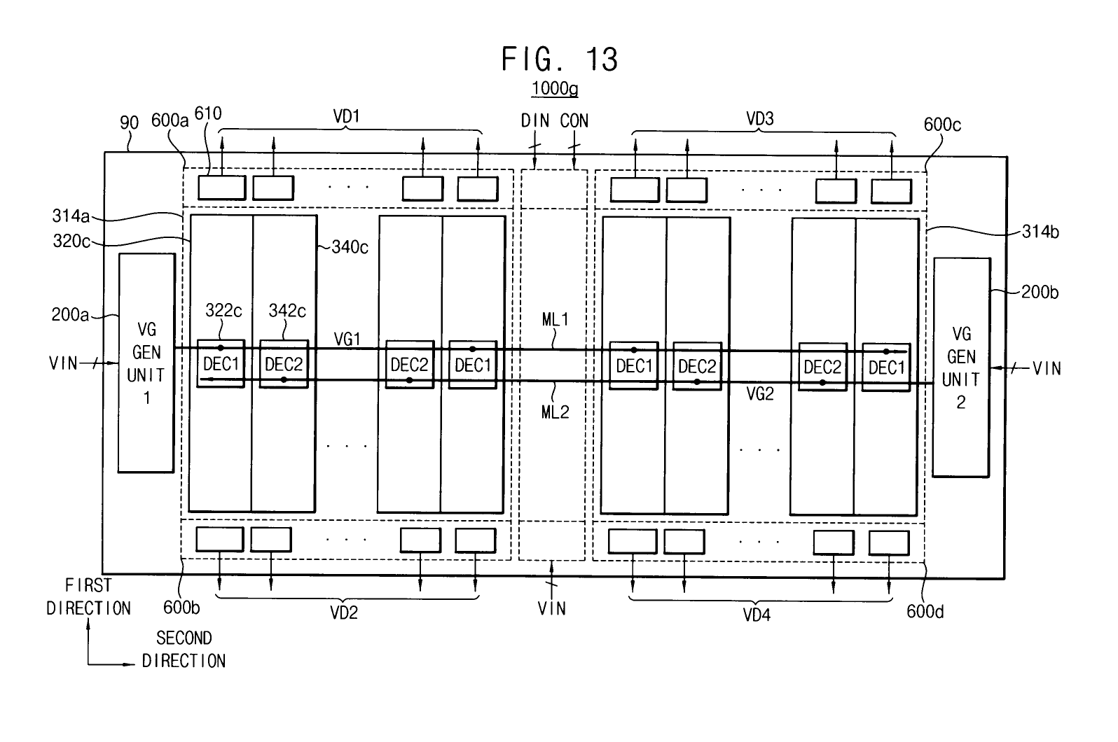

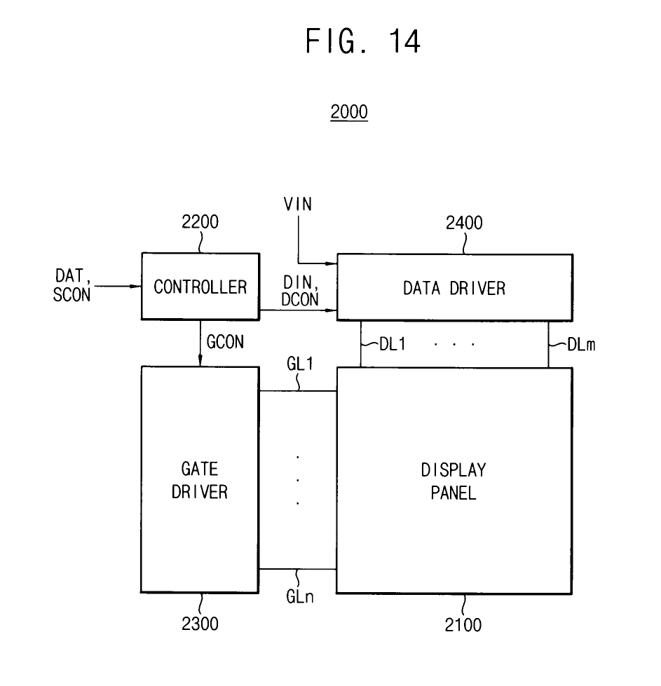

FIG. 14 is a block diagram illustrating a display device according to example embodiments.

Referring to FIG. 14, a display device 2000 may include a display panel 2100 and a display driver integrated circuit (DDI). The DDI may include a controller 2200, a gate driver 2300 and a data driver 2400.

The display panel 2100 may include a plurality of gate lines GL1 through GLn and a plurality of data lines DL1 through DLm. The display panel 2100 may include a pixel array where a plurality of pixels are arranged in a matrix form. Each pixel may be defined as corresponding region in which each of the gate lines and each of the data lines intersect. The display panel 2100 may include a LCD panel, a LED display panel, an OLED display panel, a FED panel, etc.

The controller 2200 may receive image data DAT and a system control signal SCON from an external device (e.g., a GPU), and may generate a gate driver control signal GCON, a data driver control signal DCON and data DIN based on the image data DAT and the system control signal SCON. The controller 2200 may control the gate driver 2300 based on the gate driver control signal GCON, and may control the data driver 2400 based on the data driver control signal DCON. For example, the controller 2200 may be a timing controller.

The gate driver 2300 may selectively enable the gate lines GL1 through GLn of the display panel 2100 based on the gate driver control signal GCON to select a row of the pixel array. The data driver 2400 may apply a plurality of driving voltages to the data lines DL1 through DLm of the display panel 2100 based on the data driver control signal DCON, the data DIN and an input voltage VIN provided from voltage generator (not illustrated). The display panel 2100 may be driven by the gate driver 2300 and the data driver 2400. The image corresponding to the image data DAT may be displayed on the display panel 2100.

In at least one example embodiment, the data driver 2400 may be the display driving circuit 1000 of FIG. 1. For example, the data driver 2400 may include a semiconductor die, a logic control unit, a gray-scale voltage generation unit, and a driving unit. The logic control unit may be formed in a central region of the semiconductor die, and may control the data driver 2400 based on the data driver control signal DCON. The gray-scale voltage generation unit may be formed in an edge region of the semiconductor die, and may generate a plurality of gray-scale voltages based on the input voltage VIN. The driving unit may be formed in a region of the semiconductor die between the logic control unit and the gray-scale voltage generation unit, and may generate the plurality of driving voltages based on the plurality of gray-scale voltages and the data DIN. The data driver 2400 may have a relatively small size by forming the gray-scale voltage generation unit in the edge region of the semiconductor die. According to example embodiments, the input voltage VIN may be applied to the gray-scale voltage generation unit by using FLR scheme, and/or the logic control unit may include at least one of other elements that are not included in a logic control unit of a conventional data driver.

In another example embodiment, the data driver 2400 may include a plurality of the display driving circuits 1000 of FIG. 1. The plurality of the display driving circuits 1000 may be cascade-connected.

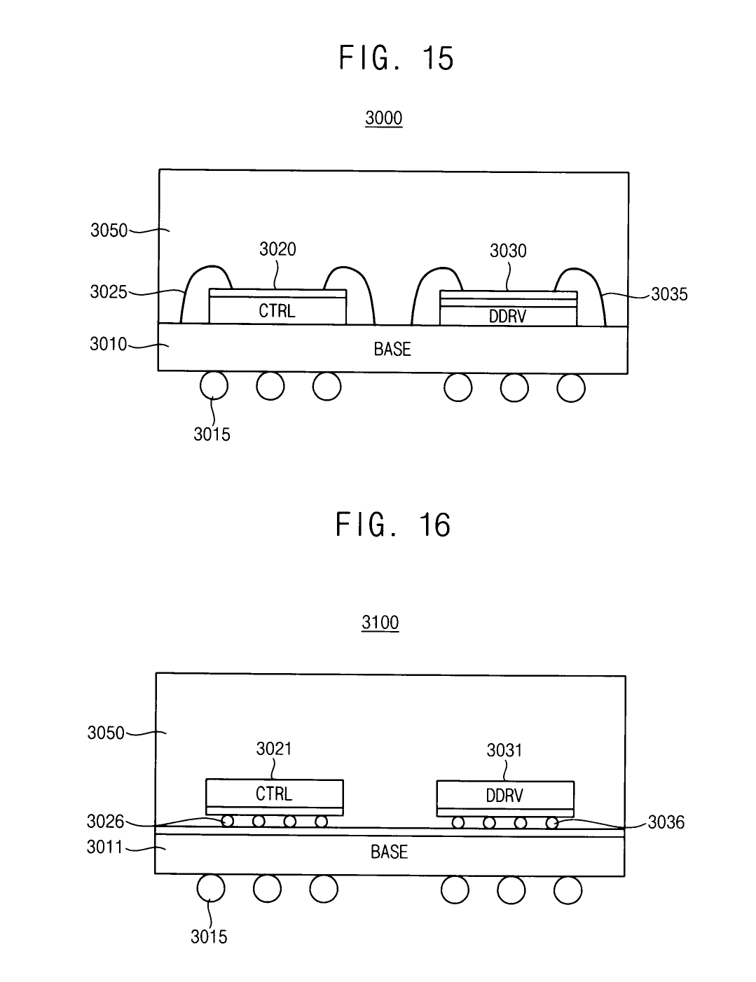

FIGS. 15, 16 and 17 are block diagrams illustrating integrated circuit packages according to example embodiments.

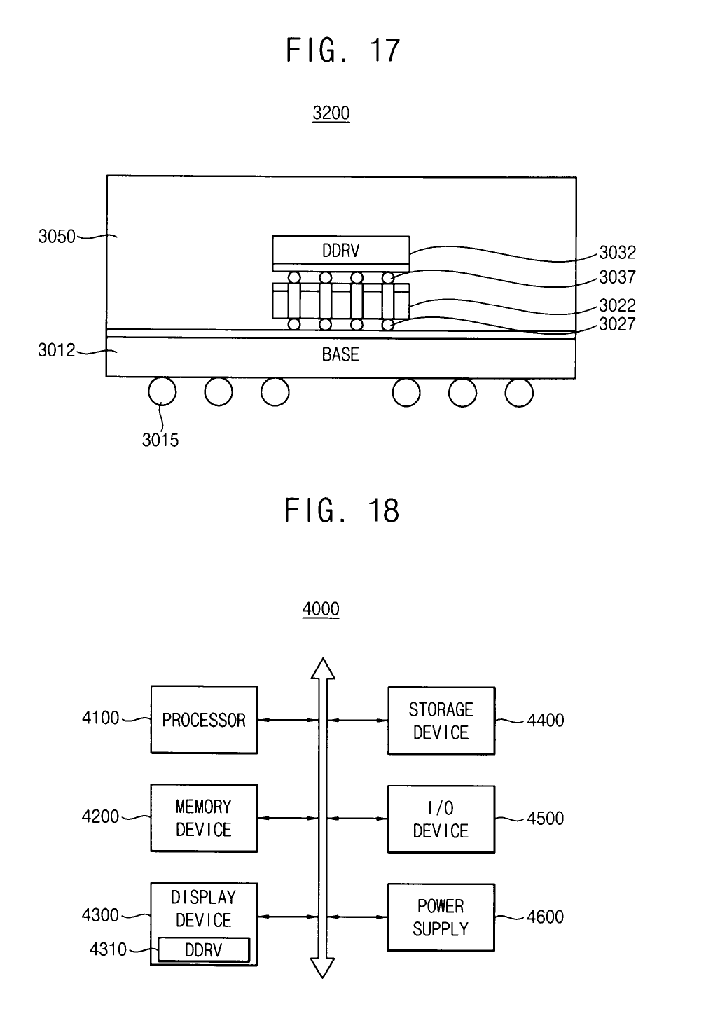

As depicted in FIGS. 15, 16 and 17, the DDI in FIG. 14 may be implemented in package form. In other words, a package 3000 of FIG. 15, a package 3100 of FIG. 16 and a package 3200 of FIG. 17 may be a DDI package, respectively. A controller chip 3020 in FIG. 15, a controller chip 3021 in FIG. 16, and a controller chip 3022 in FIG. 17 may correspond to the controller 2200 in FIG. 14. A data driver chip 3030 in FIG. 15, a data driver chip 3031 in FIG. 16, and a data driver chip 3032 in FIG. 17 may correspond to the data driver 2400 in FIG. 14.

Referring to FIG. 15, a package 3000 may include a base substrate (BASE) 3010, a controller chip (CTRL) 3020 positioned above the base substrate 3010, and a data driver chip (DDRV) 3030 positioned above the base substrate 3010.

The base substrate 3010 may be a printed circuit board (PCB) or a flexible PCB (FPCB). When the base substrate 3010 is the FPCB, the package 3000 may be referred to as a chip on film (COF) package.

The data driver chip 3030 may have a relatively small size by forming the gray-scale voltage generation unit in the edge region of the semiconductor die. In addition, the input voltage may be effectively supplied to the gray-scale voltage generation unit by using FLR scheme.

Each of the controller chip 3020 and the data driver chip 3030 may be electrically connected to the base substrate 3010 via bonding wires 3025 and 3035. In other words, the controller chip 3020 and the data driver chip 3030 may be electrically connected each other with wires in the base substrate 3010. After the chips are stacked, resin 3050 or the like may be spread on the upper of the package 3000. Bumps 3015, which are used for electric connection to external devices, may be formed under the base substrate 3010.

Referring to FIG. 16, a package 3100 may include a base substrate (BASE) 3011, a controller chip (CTRL) 3021 positioned above the base substrate 3011, and a data driver chip (DDRV) 3031 positioned above the base substrate 3011.

The base substrate 3011 may be a PCB or a FPCB. The controller chip 3021 may be electrically connected to the base substrate 3011 via input/output (I/O) bumps 3026, and the data driver chip 3031 may be electrically connected to the base substrate 3011 via I/O bumps 3036. In the package form of FIG. 16, the data driver chip 3031 may be stacked on the base substrate 3011 such that an upper surface (e.g., an active surface) of the data driver chip 3031 faces downward of the package 3100. The input voltage may be effectively applied to the gray-scale voltage generation unit through the wires in the base substrate 3011 without additional metal wire patterns formed above the active surface of the data driver chip 3031.

Referring to FIG. 17, a package 3100 may include a base substrate (BASE) 3012, a controller chip (CTRL) 3022 positioned above the base substrate 3012, and a data driver chip (DDRV) 3032 positioned above the controller chip 3022.

The base substrate 3012 may be a PCB or a FPCB. The controller chip 3022 may be electrically connected to the base substrate 3012 via I/O bumps 3027, and the data driver chip 3032 may be electrically connected to the controller chip 3022 via I/O bumps 3037. In the package form of FIG. 17, the controller chip 3022 and the data driver chip 3032 may be directly and electrically connected each other without wires in the base substrate 3012. The data driver chip 3032 may be stacked on the controller chip 3022 such that an upper surface of the data driver chip 3032 faces downward of the package 3200.

Although not illustrated in FIGS. 15, 16 and 17, the package 3000, the package 3100 and the package 3200 may further include a gate driver chip corresponding to the gate driver 2300 in FIG. 14.

FIG. 18 is a block diagram illustrating an electronic system including the display device according to example embodiments.

Referring to FIG. 18, the electronic system 4000 may include a processor 4100, a memory device 4200, a display device 4300, a storage device 4400, an I/O device 4500 and a power supply 4600. Although not illustrated in FIG. 18, the electronic system 4000 may further include a plurality of ports for communicating a video card, a sound card, a memory card, a universal serial bus (USB) device, other electric devices, etc.

The processor 4100 may perform various computing functions. The processor 4100 may be a microprocessor, a central processing unit (CPU), etc. The processor 4100 may be connected to the memory device 4200, the display device 4300, the storage device 4400, and the I/O device 4500 via a bus such as an address bus, a control bus, a data bus, etc. The processor 4100 may be connected to an extended bus such as a peripheral component interconnection (PCI) bus.

The memory device 4200 may store data for operations of the electronic system 4000. For example, the memory device 4200 may include a dynamic random access memory (DRAM) device, a static random access memory (SRAM) device, an erasable programmable read-only memory (EPROM) device, an electrically erasable programming read-only memory (EEPROM) device, a flash memory device, etc.

The storage device 4400 may include a solid state drive device, a hard disk drive device, a CD-ROM device, etc. The I/O device 4500 may include input devices such as a keyboard, a keypad, a mouse, etc, and output devices such as a printer, etc. The power supply 4600 may provide power to the electronic system 4000.

The display device 4300 may be the display device 2000 of FIG. 14. The display device 4300 may include the data driver 4310 that has a relatively small size by forming the gray-scale voltage generation unit in the edge region of the semiconductor die.

The above described example embodiments may be used in any device or system including a display device, such as a mobile phone, a smart phone, a personal digital assistant (PDA), a portable multimedia player (PMP), a digital camera, a digital television, a set-top box, a music player, a portable game console, a navigation device, a personal computer (PC), a server computer, a workstation, a tablet computer, a laptop computer, a smart card, a printer, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the inventive concepts. Accordingly, all such modifications are intended to be included within the scope of the inventive concepts as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the following claims.

What is claimed is:

1. A display driving circuit, comprising:
a semiconductor die;
a logic control unit on a central region of the semiconductor die, the logic control unit configured to control the display driving circuit based on a control signal;
a gray-scale voltage generation unit on an edge region of the semiconductor die, the gray-scale voltage generation unit configured to generate a plurality of gray-scale voltages based on an input voltage; and
a driving unit on a region of the semiconductor die between the logic control unit and the gray-scale voltage generation unit, the driving unit configured to generate a plurality of driving voltages based on the plurality of gray-scale voltages and input data.

2. The display driving circuit of claim 1, wherein
the semiconductor die has a first side that is substantially parallel to a first direction and a second side that is substantially parallel to a second direction, the second direction being different from the first direction, and
the gray-scale voltage generation unit is adjacent to the first side and arranged in the first direction.

3. The display driving circuit of claim 2, wherein a length of the first side is smaller than a length of the second side.

4. The display driving circuit of claim 1, further comprising:
a voltage input pad unit configured to receive the input voltage, the voltage input pad unit including a plurality of voltage input pads on an active surface of the semiconductor die, the input voltage being applied to the gray-scale voltage generation unit through a metal wire layer above the active surface of the semiconductor die.

5. The display driving circuit of claim 4, wherein the metal wire layer includes:
a plurality of metal wire patterns above the active surface of the semiconductor die, each metal wire pattern electrically connecting the gray-scale voltage generation unit to one of the plurality of voltage input pads; and
an insulation layer on the plurality of metal wire patterns.

6. The display driving circuit of claim 1, further comprising:
a signal input pad unit configured to receive the control signal and the input data, the input data including first input data and second input data that are a pair of differential data, the logic control unit including a comparison block configured to compare the first input data with the second input data to generate internal data.

7. The display driving circuit of claim 1, wherein
the gray-scale voltage generation unit includes a first gray-scale voltage generation unit and a second gray-scale voltage generation unit, and the plurality of gray-scale voltages includes first gray-scale voltages and second gray-scale voltages, wherein
the first gray-scale voltage generation unit is adjacent to a first side of the semiconductor die and arranged in a first direction along the first side of the semiconductor die, the first gray-scale voltage generation unit configured to generate the first gray-scale voltages, and
the second gray-scale voltage generation unit is adjacent to a second side of the semiconductor die and arranged in the first direction along the second side of the semiconductor die and is configured to generate the second gray-scale voltages, wherein the first side is substantially parallel to the first direction and the second side corresponds to the first side, and
the driving unit includes a first driving unit and a second driving unit, the first driving unit is formed in a first region of the semiconductor die between the logic control unit and the first gray-scale voltage generation unit, and the second driving unit is formed in a second region of the semiconductor die between the logic control unit and the second gray-scale voltage generation unit.

8. The display driving circuit of claim 7, wherein the driving unit includes a plurality of driver cells disposed along a second direction, the second direction is different from the first direction.

9. The display driving circuit of claim 8, wherein the plurality of driver cells include:
first driver cells disposed in a first row of the driving unit along the second direction, and
second driver cells disposed in a second row of the driving unit along the second direction, each first driver cell including a first decoder configured to select one of the first gray-scale voltages, each second driver cell including a second decoder configured to select one of the second gray-scale voltages, and the second row is adjacent to the first row in the first direction.

10. The display driving circuit of claim 9, further comprising:
a first metal wire configured to supply the first gray-scale voltages to the first decoder; and
a second metal wire configured to supply the second gray-scale voltages to the second decoder.

11. The display driving circuit of claim 8, wherein the plurality of driver cells include first driver cells and second driver cells, each first driver cell including a first decoder configured to select one of the first gray-scale voltages, each second driver cell including a second decoder configured to select one of the second gray-scale voltages, and the first driver cells and the second driver cells are alternately disposed along the second direction.

12. The display driving circuit of claim 8, wherein each driver cell includes:
a data transmission unit configured to generate first data by processing the input data;
a decoder configured to select one of the plurality of gray-scale voltages based on the first data; and
an output buffer configured to generate one of the plurality of driving voltages by buffering the selected gray-scale voltage.

13. The display driving circuit of claim 12, wherein the data transmission unit includes:
a shift register configured to generate a latch clock signal based on the control signal; and
a data latch configured to generate the first data by latching the input data based on the latch clock signal.

14. The display driving circuit of claim 1, further comprising:
a voltage output pad unit configured to output the plurality of driving voltages.

15. A display device, comprising:
a display panel including a plurality of gate lines and a plurality of data lines;
a gate driver configured to selectively enable the gate lines of the display panel;
a data driver configured to apply a plurality of driving voltages to the data lines of the display panel; and
a controller configured to control the gate driver and the data driver, the data driver including,
a semiconductor die;
a logic control unit on a central region of the semiconductor die, the logic control unit configured to control the data driver based on a control signal received from the controller;
a gray-scale voltage generation unit on an edge region of the semiconductor die, the gray-scale voltage generation unit configured to generate a plurality of gray-scale voltages based on an input voltage; and
a driving unit on a region of the semiconductor die between the logic control unit and the gray-scale voltage generation unit, the driving unit configured to generate the plurality of driving voltages based on the plurality of gray-scale voltages and input data received from the controller.

16. A display driving circuit comprising:
a first voltage generation unit on an end of a substrate;
a second voltage generation unit on an opposite end of the substrate; and
a plurality of circuit units between the first voltage generation unit and the second voltage generation unit,
the first voltage generation unit, the second voltage generation unit, and the plurality of circuit units being configured to drive a display device.

17. The display driving circuit of claim 16, wherein the plurality of circuit units includes:
a logic control unit on a central region of the substrate;
a first driving unit between the logic control unit and the first voltage generation unit; and
a second driving unit between the logic control unit and the second voltage generation unit.

18. The display driving circuit of claim 17, wherein the first and second driving units include:
a first driver cell disposed in a first row of the first and second driving units, each first driver cell including at least one first decoder; and
a second driver cell disposed in a second row of the first and second driving units, each second driver cell including at least one second decoder.

19. The display driving circuit of claim 17, wherein the first and second driving units include:
a first driver cell including at least one first decoder; and
a second driver cell including at least one second decoder,
the at least one first decoder and the at least one second decoder are disposed in a first row of the first and second driving units, and
the at least one first decoder and the at least one second decoder are alternately arranged in the first row.

20. The display driving circuit of claim 17, wherein the first and second driving units include:
a first driver cell disposed in a first row of the first and second driving units; and
a second driver cell disposed in a second row of the first and second driving units,
the first driver cell and the second driver cell including at least one first decoder adjacent to at least one second decoder.
